(19) United States
(12) Patent Application Publication
(10) Pub. No.: US 2005/0033578 A1
(43) Pub. Date: Feb. 10, 2005

(54) Text-to-video sign language translator

(76) Inventor: Mara Zuckerman, New York, NY (US)

Correspondence Address: JOSEPH FRANCIS MURPHY, 101 WEST 23RD STREET, SUITE 2367, NEW YORK, NY, 10011, US

(21) Appl. No.: 10/636,488

(22) Filed: Aug. 7, 2003

(51) Int. Cl. G10L 11/00

(52) U.S. Cl. 704/271

(57) ABSTRACT

An automated Text-to-Video Sign Language Translation method is disclosed. Text input is made via keyboard into a computer running software which parses the text for keywords, and orders those keywords into a string which corresponds to the order in which they would appear in a sign language communication. The ordered keywords are each used in order to retrieve from CD-ROM the image file depicting a sign language sign which is corresponding to each keyword. These image files are displayed in order on the video display screen to complete the communication to the Deaf Person (DP). It is thought that the method according to the current invention will prove particularly useful in hospital emergency rooms which may treat a DP.

### CROSS REFERENCE TO RELATED APPLICATIONS

This application is not known to be related to any other application.

### APPENDIX

This application does not include a computer program appendix.

### STATEMENT REGARDING FEDERALLY SPONSORED RESEARCH

Not applicable.

“Saying It In Sign”

### BACKGROUND OF THE INVENTION

Sign language is, for most deaf people, the first language learned. In that sense, then, it is their native language, the one they feel most comfortable using. Indeed, it may be the only language they know. Although sign language may, in America, be based on the English Language, it is as distinct a language from English as is, say, Spanish. Of course, conveying a message to a deaf person in his or her native language, i.e. sign language, is superior to conveying it to him or her in another language, say, e.g. by written English text or by “speech reading” a.k.a. “lip-reading”. The deaf person will understand the sign language message more readily and fully than he or she will the written English text message (which, depending on his or her knowledge, may not be understood at al). In situations where communication is critical, e.g. in a Hospital Emergency Room, it would be extraordinarily desirable to enable a hearing person (HP) person who does not know sign language to communicate with a deaf person (DP) who does know sign language by providing a device-based system which facilitates the written text (e.g. text typed into a computer keyboard by the HP) to be translated into and displayed as sign language text (i.e. as sign language gestures displayed to the DP via a video display means connected to a computer.) This text-to-sign translation system is herein sometimes referred to as the “Saying it in Sign” System, or simply as “Saying it in Sign”. “Saying it in Sign” will allow hearing people who know NO sign language to communicate with deaf people, without the use of a human sign language interpreter. “Saying it in Sign” employs specialized software that has as input typed English words or phrases and provides as output the equivalent sign language gestures. It is these signs that are then displayed on the video display.

### BRIEF DESCRIPTION OF THE DRAWING

FIG. 1 is a flowchart showing the steps in accordance with the present invention.

FIG. 2 is a block diagram of the presently preferred embodiment of the system according to the present invention.

FIG. 3 is a detail of the block diagram of FIG. 2.

### DETAILED DESCRIPTION OF THE PRESENTLY PREFERRED EMBODIMENTS

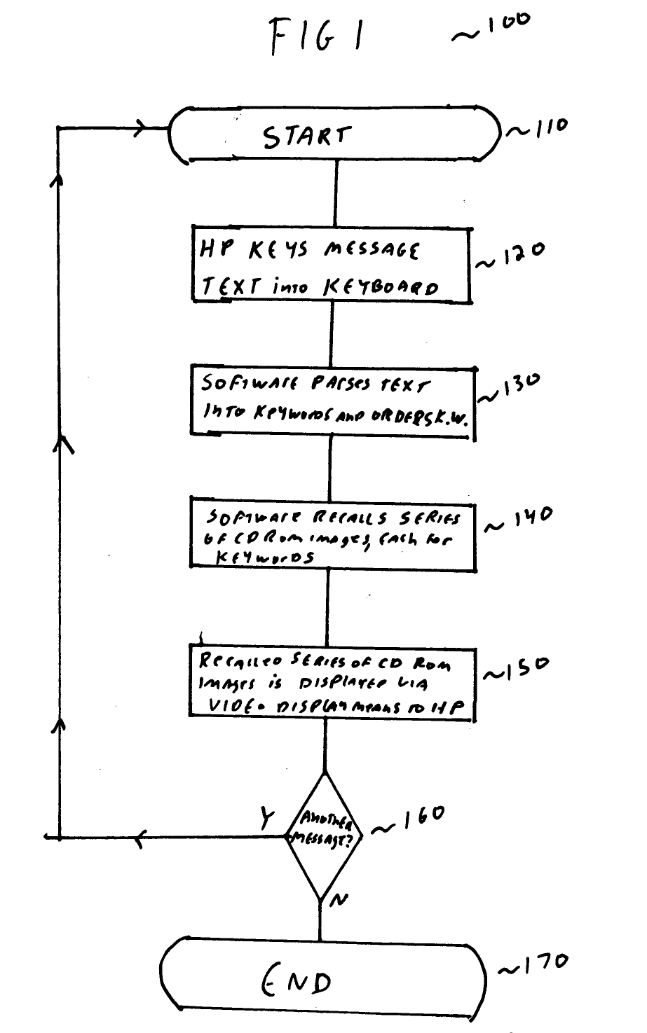

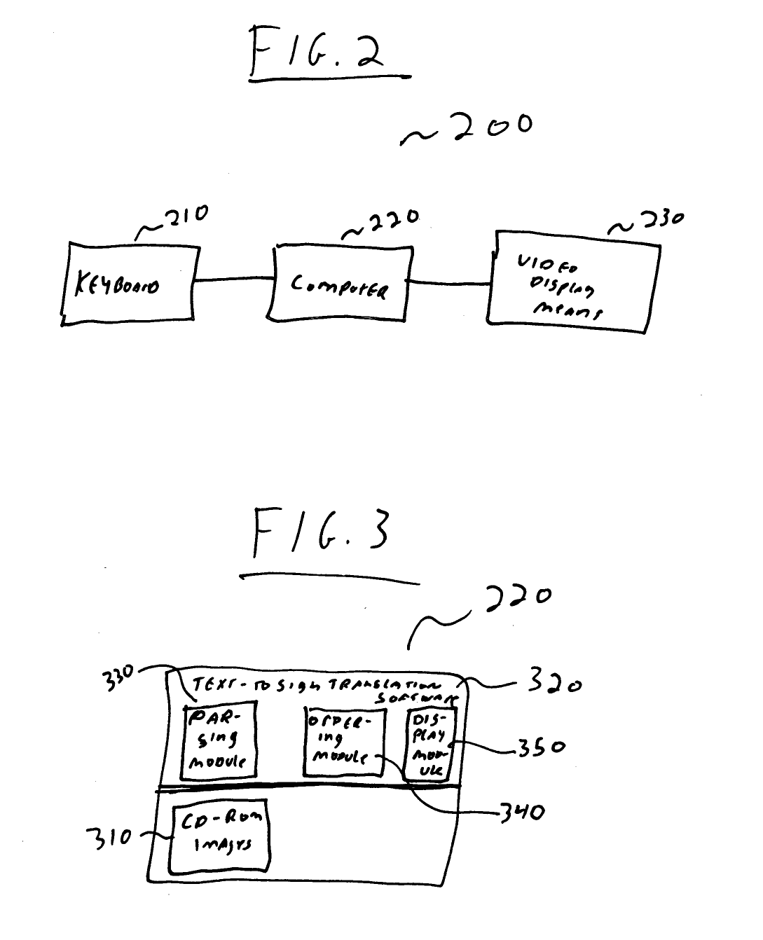

In accordance with the present invention, a hearing person (HP) who needs to communicate with a deaf person (DP) follows the following steps, shown in the flowchart at FIG. 1 First (step 120), the HP keys his message text into keyboard means 210 connected to computer 220: Next (step 130) software 320 on the computer 220 translates the text into sign language symbols. Next (step 140), for each sign language symbol, software recalls an image file corresponding to that symbol. This library of image files of signs used in “Saying it in Sign” will have been created by videoing each sign individually to incorporate its movement. The recall may be accomplished by use of any one of a number of software packages and software engines such as are well-known to those of ordinary skill in the relevant arts; one of these is known as MACROMEDIA DIRECTOR; another is known as “ByteQuest CD-ROM Satellite Kit” available through ByteQuest Technologies Inc., of Ottawa, Ontario, Canada. Next, the video display displays (step 150) the symbols in the proper sequence, as determined by the grammatical and syntactical rules of American Sign Language (ASL). These rules are described in the book “Signing Naturally: Teacher's Curriculum Guide—Level One (Vista Curriculum Series)”, which was written by Cheri Smith, Ella M. Lentz, and Ken Mikos; published by: Dawn Sign Press; ISBN: 0915035073, the contents of which are hereby incorporated by reference. The software implemented in accordance with the present invention comprises parsing software, which deconstructs each text message into keywords, which are identified words (occurring singly, or in phrases), and further comprises ordering software, which orders the keywords in a string order corresponding to the order in which they would be used in a sign language message. The parsing software and the ordering software may be said to “know” the rules of ASL grammar, e.g. what icon/shape/image to match to what words, including defaults of what to do if an image is not there, or if it is a proper name, or if it is not part of the syntax of ASL, etc. Note that ASL signs are not merely static; they incorporate action and movement which is a part of the sign itself as well as the syntax of the language, and so the files containing the signs may be MPEG or similar moving-picture format; they may additionally or alternatively be files comprising information suitable for producing a three-dimensional (3-D) display. In this fashion the signs are shown on the video display screen in a complete ASL sentence. With reference to FIG. 3, it is seen that computer 220 comprises a CD-ROM of stored images, as well as a text to sign language translation software 320, which itself comprises text parsing software module 330, a keyword ordering software module 340, and an image file retrieval software module 350.

It should be understood that the practice of the invention is not limited to Emergency Rooms, and that it is suitable (when used with the appropriate dictionary and vocabulary) for other venues of urgent communication, e.g. Police Stations, Legal Proceedings, etc. Indeed, it may also be used for less urgent, even casual or ordinary communications, e.g. with a bank teller or,shop,keeper.

The deaf person (DP) will see the original sentence which was typed in English by the HP show up on the computer screen encoded into a proper ASL or Signed English sentence and thus allow the DP to understand. The system will check (step 160) to see if the HP enters another phrase to translate; if so the foregoing steps are repeated.

While not included in the present invention, the DP in response to the displayed message may either speak, type or gesture his response back to the HP.

An exemplary application for the system is in the hospital emergency room. To permit this, the library of image files will have been created using a dictionary of medical terminology. When a deaf patient arrives in the emergency room, while waiting for a sign language interpreter (required by law) to arrive to facilitate communication, doctors can “triage” the patient without delay using the “Saying it in Sign” method and apparatus according to the present invention.

In an alternative embodiment, the software may be loaded on a server computer which is accessed by the client computer into which the text is input, and from which the sign language gestures may be output (displayed).

1. A method of performing Text-to-Video Sign Language Translation, comprising the steps of:
a. Providing a computer having keyword-activated image retrieval software, and further having at least one keyboard input means and at least one video output means;
b. Inputting into said computer via said keyboard input means a text message to be translated;
c. Parsing said text message to understand its grammatical, syntactical, and lexical structure, and extracting from said text message at least one of a plurality of keywords,
d. Ordering said plurality of keywords into a string representing the order in which they would be presented in a sign language conversation,
e. Serially retrieving from CD-ROM the image file corresponding to each of said plurality of keywords, said serially retrieving being done in the order in which said keywords appear in said string, and
f. Serially displaying on video output means the image files retrieved.

2. A method of performing Text-to-Video Sign Language Translation, comprising the steps of:
a. Providing a computer having at least one keyboard input means and at least one video output means;
b. Inputting into said computer via said keyboard input means a text message to be translated;
c. Serially displaying on video output means the images of the sign language gestures corresponding to said input text message.
